(19) United States
(12) Patent Application Publication
(10) Pub. No.: US 2007/0162557 A1
(43) Pub. Date: Jul. 12, 2007

(54) SYSTEM AND METHOD FOR TRANSFERRING SERVICE REQUESTS

(75) Inventors: DA-PENG LI, Shenzhen (CN); CHIEN-FA YEH, Taipei Hsien (TW); CHUNG-I LEE, Taipei Hsien (TW); NING HUANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/565,643

(22) Filed: Dec. 1, 2006

(30) Foreign Application Priority Data
Jan. 6, 2006 (CN) 200610032808.3

(51) Int. Cl. G06F 15/167

(52) U.S. Cl. 709/214; 709/213

(57) ABSTRACT

A method for transferring service requests is provided. The method includes the steps of: proving a storage in a control server (1) for storing preset commands and server status codes; selecting a TCP/UDP port of the control server and allocating a first proxy server (3) for the control server according to the TCP/UDP port; detecting whether the first proxy server is operational according to a server status code returned from the fist proxy server; transmitting a service request from a client computer (2) to the first proxy server if the first proxy server is operational; receiving a returned results from the proxy server; and transmitting the returned results to the client computer. A related system is also disclosed.

### BACKGROUND OF THE INVENTION

1. Field of the Invention

The present invention generally relates to systems and methods for controlling communication services in a communication system, and more particularly to a system and method for transferring service requests via proxy servers.

2. Description of Related Art

With continual spread of the Internet, a variety of services have hitherto been provided over the Internet through web servers. However, there are more and more limitations for enterprise users while searching desired information. For example, a web server generally limits access times or contents for the enterprise user when the web server connects to a network. Therefore, it brings many inconveniences for the enterprise user who accesses the web server frequently.

On the other hand, there is no safe mechanism for preventing interception when the enterprise user directly accesses the web server. In general, Internet hackers easily obtain an internet protocol (IP) address of the user computer. Thus the security of data in the user computer cannot be assured because the hackers can easily attack data in the user computer.

What is needed, therefore, is a system and method for transferring service requests that can automatically allocate proxy servers for the user computers, so as to prevent the data to be attacked by the hackers, and assure the security of the data in the user computers.

### SUMMARY OF THE INVENTION

A system for transferring service requests in accordance with a preferred embodiment includes: at least a proxy server and a control server connected to a plurality of client computers. The control server includes a service request transferring unit and a storage. The service request transferring unit is configured for detecting whether a first allocated proxy server is operational, allocating a second proxy server for the control server when the first allocated proxy server is not operational, and for transferring data between client computers and the proxy servers. The storage is configured for storing at least a preset command and server status codes.

The service request transferring unit comprises: a server selecting module configured for selecting a TCP/UDP port of the control server according to information from one of the client computers, allocating one of the proxy servers for the control server according to the TCP/UDP port; a transmitting module configured for transmitting the preset command to the first allocated proxy server; a receiving module configured for receiving a server status code returned from the proxy server; and a status detecting module configured for detecting whether the first allocated proxy server is operational.

The server selecting module is further configured for allocating a second proxy server for the control server when the first allocated proxy server is not operational. The receiving module is further configured for receiving service requests from one of the client computers, and for receiving returned results from the proxy server. The transmitting module is further configured for transmitting a service request from the client computer to the proxy server when the receiving module receives the service request from the client computer, and transmitting corresponding returned results from the proxy server to the client computer.

Another preferred embodiment provides a method for transferring service requests is also disclosed. The method includes the steps of: (a) proving a storage for storing preset commands and server status codes; (b) selecting a TCP/UDP port of a control server and allocating a first proxy server for the control server according to the TCP/UDP port; (c) detecting whether the first proxy server is operational according to a server status code returned from the fist proxy server; (d) transmitting a service request from a client computer to the first proxy server if the first proxy server is operational; (e) receiving a returned results from the proxy server; and (f) transmitting the returned results to the client computer.

Other advantages and novel features of the embodiments will be drawn from the following detailed description with reference to the attached drawings, in which:

### BRIEF DESCRIPTION OF THE DRAWINGS

FIG. 1 is a schematic diagram of hardware configuration of a system for transferring service requests in accordance with the preferred embodiment;

FIG. 2 is a schematic diagram of function modules of a control server; and

FIG. 3 is flow chart of a preferred method for transferring service requests by implementing the system of FIG. 1.

### DETAILED DESCRIPTION OF THE INVENTION

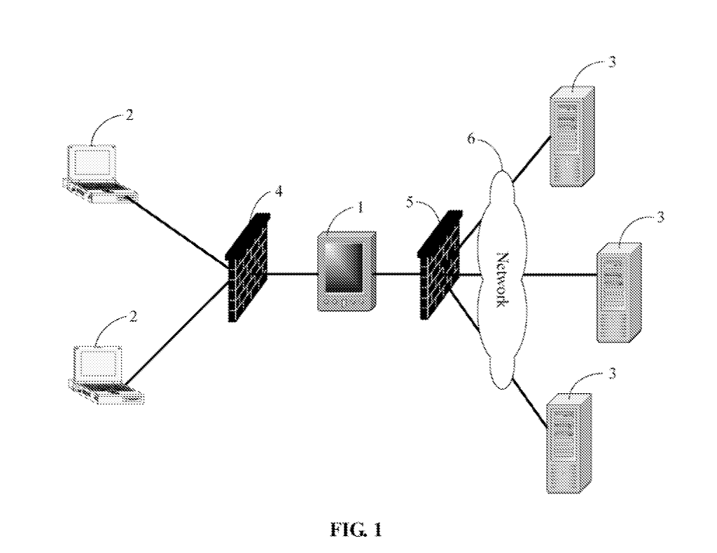

FIG. 1 is a schematic diagram of hardware configuration of a system for transferring service requests (hereinafter, “the system”) in accordance with the preferred embodiment. The system includes a control server 1, a plurality of client computers 2 connected to the control server 1 via an internal firewall 4, and a plurality of proxy servers 3 connected to the control server 1 via an external firewall 5 and a network 6.

The control server 1 is configured for detecting whether one of the proxy servers 3 (also represented with a first proxy server) is operational, allocating another of the proxy servers 3 (also represented with a second proxy server) when the one of the proxy servers 3 is not operational, and transferring data between the client computers 2 and the proxy servers 3. The internal firewall 4, the control server 1, and the external firewall 5 consist of a demilitarized zone (DMZ) for securing communications between the client computers 2 and the proxy server 3. The network 6 may be an intranet, the Internet, or any other suitable electronic communications network. The proxy servers 3 connect to a plurality of web servers (not shown in FIG. 1) that provides various data for users.

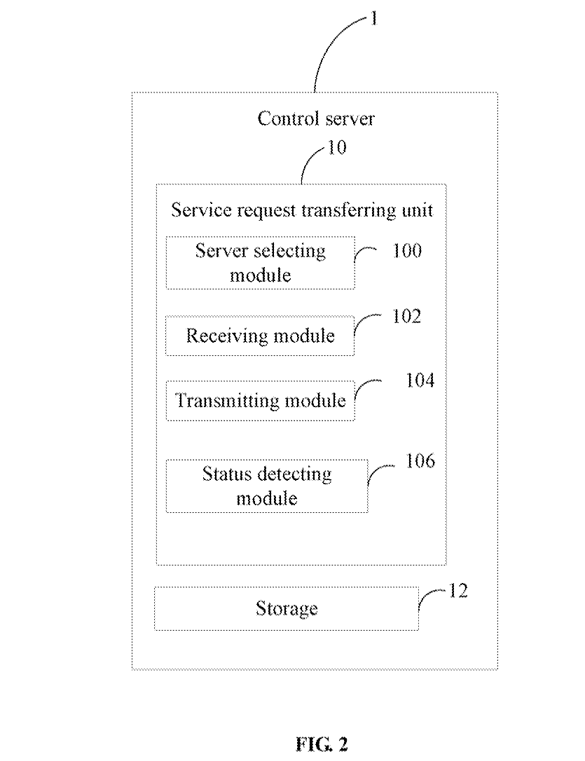

FIG. 2 is a schematic diagram of function modules of the control server 1 of FIG. 1. In the preferred embodiment, the control server 1 includes a service request transferring unit 10 and a storage 12. The storage 12 is configured for storing preset commands and corresponding server status codes. The server status code includes a failure code and a success code. If a proxy server 3 times out or returns the failure code to the control server 1, the control server 1 will detect that the proxy server 3 is offline/not operational. Otherwise, if the proxy server 3 returns the success code to the control server 1, the control server 1 will detect that the proxy server 3 is operational/online/connectable. In other preferred embodiments, the storage 12 can be independent from the control server 1.

The service request transferring unit 10 includes a server selecting module 100, a transmitting module 102, a receiving module 104, and a status detecting module 106.

The server selecting module 100 is configured for selecting a TCP/UDP port of the control server 1 according to the information from one of the client computers 2, and for connecting one of the proxy servers 3 to the control server 1 through the selected TCP/UDP port. The TCP/UDP port is a communication channel between the client computer 2 and the proxy server 3. The information may be a uniform resource locator (URL), for example, http://www.uspto.gov. The TCP/UDP port may be port 80, port 8080, port 3128, or any other suitable ports.

The receiving module 102 is configured for receiving service requests from the client computers 2, and for receiving the server status codes or returned service results from the proxy servers 3.

The transmitting module 104 is configured for transmitting the service requests received from one of the client computers 2 to the proxy server 3, and for transmitting the service results returned from the proxy server 3 to the client computer 2 correspondingly. The transmitting module 102 is further configured for transmitting the preset command in the storage 12 to the proxy server 3.

The status detecting module 106 is configured for detecting whether the proxy server 3 is operational according to the server status code returned from the proxy server 3. If the proxy server 3 returns the success code to the control server 1, the status detecting module 106 detects that the proxy server 3 is operational. Otherwise, if the proxy server 3 allocated returns the failure code to the control server 1, the status detecting module 106 detects that the proxy server 3 is not operational.

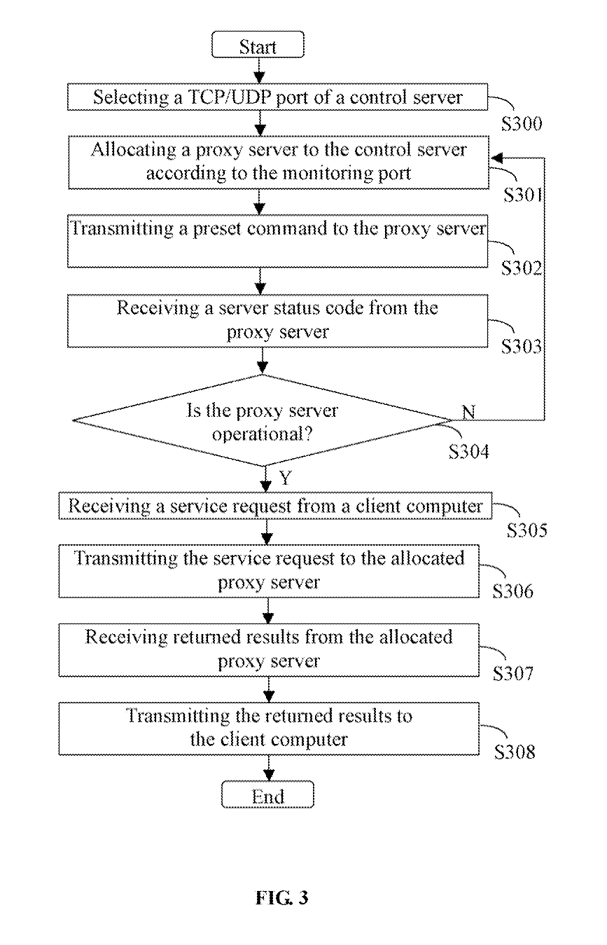

FIG. 3 is a flow chart of a preferred method for transferring service requests by implementing the system as described above. In step S300, when an URL address, for example, http://www.uspto.gov is inputted to one of the client computers 2, the server selecting module 100 selects the TCP/UDP port of the control server 1 for the client computer 2. The TCP/UDP port is a communication channel between the client computer 2 and the proxy server 3.

In step S301, the server selecting module 100 allocates one of the proxy servers 3 to the control server 1 according to the TCP/UDP port.

In step S302, the transmitting module 104 transmits the preset command in the storage 12 to the proxy server 3.

In step S303, the receiving module 102 receives a server status code returned from the proxy server 3.

In step S304, the status detecting module 106 detects whether the proxy server 3 is operational according to the server status code. The server status code includes the failure code and the success code. If the proxy server 3 is not operational, the procedure returns to step S301 to allocate a second proxy server 3 to the client computer 2.

Otherwise, if the proxy server 3 is operational, in step S305, the receiving module 102 receives the service request from the client computer 2.

In step S306, the transmitting module 104 transmits the service request to the proxy server 3 that is operational. After the proxy server 3 receives the service request, the proxy server 3 connects to the URL address for performing the service request.

In step S307, the receiving module 104 receives the returned service results from the proxy server 3 allocated. In step S308, the transmitting module 104 transmits the returned service results from the control server 1 to the client computer 2 correspondingly.

It should be emphasized that the above-described embodiments, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for transferring service requests, comprising at least one proxy server and at least one control server connected to a plurality of client computers, the at least one control server comprising:
a service request transferring unit configured for allocating a first proxy server for the control server, allocating a second proxy server when the first proxy server is not operational, and for transferring data between the client computers and the proxy servers; and
a storage configured for storing at least a preset command and server status codes.

2. The system according to claim 1, wherein the service request transferring unit comprises a server selecting module configured for selecting a TCP/UDP port of the control server according to information sent from one of the client computers, allocating the first proxy server for the control server according to the TCP/UDP port, and for allocating the second proxy server for the control server when the first proxy server is not operational.

3. The system according to claim 1, wherein the service request transferring unit comprises a transmitting module configured for transmitting the preset command to the first allocated proxy server.

4. The system according to claim 1, wherein the service request transferring unit comprises a receiving module configured for receiving a server status code returned from the first allocated proxy server, receiving service requests from one of the client computers, and for receiving returned results from the first allocated proxy server.

5. The system according to claim 1, wherein the service request transferring unit comprises a status detecting module configured for detecting whether the first allocated proxy server is operational.

6. The system according to claim 4, wherein the transmitting module is further configured for transmitting a service request from the client computer to the proxy server when the receiving module receives the service request, and transmitting corresponding returned results from the proxy server to the client computer.

7. An enabled-computerized method for transferring service requests, the method comprising the steps of:
proving a storage for storing preset commands and server status codes;
selecting a TCP/UDP port of a control server and allocating a first proxy server for the control server according to the TCP/UDP port;
detecting whether the first proxy server is operational according to a server status code returned from the fist proxy server;
transmitting a service request from one of client computers to the first proxy server if the first proxy server is operational;
receiving a returned results from the first proxy server; and
transmitting the returned results to the client computer.

8. The method according to claim 7, further comprising the steps of:
transmitting a preset command to the first proxy server; and
receiving a server status code returned from the first proxy server.

9. The method according to claim 7, further comprising the step of:
allocating a second proxy server for the control server if the first proxy server is not operational.

10. The method according to claim 7, wherein the server status code includes a failure code and a success code.

11. The method according to claim 10, wherein the detecting step further comprising the step of:
returning the success code to the control server if the first proxy server is operational; or returning the failure code to the control server if the first proxy server is not operational.
